(19) United States
(12) Patent Application Publication
(10) Pub. No.: US 2014/0024535 A1
(43) Pub. Date: Jan. 23, 2014

(54) SUPERCONDUCTING WIRE ROD MANUFACTURING APPARATUS, AND METHOD OF MANUFACTURING THE SAME

(71) Applicant: KABUSHIKI KAISHA TOSHIBA, (US)

(72) Inventor: Daiki IINO, Kamakura-shi (JP)

(73) Assignee: KABUSHIKI KAISHA TOSHIBA, Tokyo (JP)

(21) Appl. No.: 13/747,855

(22) Filed: Jan. 23, 2013

(30) Foreign Application Priority Data
Jan. 23, 2012 (JP) 2012-011226

(51) Int. Cl. H01B 12/02

(52) U.S. Cl. CPC H01B 12/02
USPC 505/434; 118/58; 118/722; 427/62

(57) ABSTRACT

A manufacturing apparatus which manufactures a superconducting wire rod, includes first, second, and third chambers which are connected in series, an exhaust device which exhaust air from the first to third chambers, a carrier device which carries a substrate such that the substrate passes through the first to third chambers in this order, a first film formation device which forms a metal layer on the substrate in the first chamber, a first gas supply device which supplies oxidation gas to the second chamber to oxidize a surface of the metal layer, and a second film formation device which forms an oxide layer on the metal layer, the surface of which has been oxidized, in the third chamber.

### CROSS-REFERENCE TO RELATED APPLICATIONS

This application is based upon and claims the benefit of priority from Japanese Patent Application No. 2012-011226, filed Jan. 23, 2012, the entire contents of which are incorporated herein by reference.

### FIELD

Embodiments described herein relate generally to a superconducting wire rod manufacturing apparatus, and a superconducting wire rod manufacturing method.

### BACKGROUND

Superconductors have the property that its electric resistance disappears at very low temperature which is close to absolute zero, and thus are expected to be applied to, for example, power-transmission lines and electromagnets.

To obtain a superconducting layer having excellent property, it is necessary to orient crystal grains such that orientations of the crystal lattices agree in the superconducting layer, that is, orient a superconducting wire rod. By orientation, it is possible to make a large superconducting current flow through the superconducting wire rod.

To orient a superconducting wire rod, for example, adopted is a method of preparing a metal substrate, one principal plane of which is formed of a specific lattice plane, such as a nickel substrate, one principal plane of which is formed of (200) plane, depositing an buffer layer such that the lattice constant of the buffer layer matches the lattice constant of the substrate, and forming a superconducting layer on the buffer layer such that the lattice constant of the superconducting layer matches the lattice constant of the buffer layer.

In the above method, there are cases where a natural oxide film formed on a surface of the nickel substrate is removed by reduction before the buffer layer is formed. An oxide is deposited on the substrate, from which the natural oxide has been removed, to form an oxide layer which functions as a barrier layer, and an oxide buffer layer is deposited on the oxide layer.

### BRIEF DESCRIPTION OF THE DRAWINGS

FIG. 1 is a schematic cross-sectional view of an example of an apparatus of manufacturing a superconducting wire rod according to an embodiment.

FIG. 2 is a schematic cross-sectional view of an example of the superconducting wire rod.

FIG. 3 is a graph which illustrates the relationship between a peak intensity ratio of each lattice plane and oxygen exposure time, obtained by X-ray crystal diffraction measurement of a buffer layer of the superconducting wire rod according to the embodiment.

### DETAILED DESCRIPTION

An apparatus of manufacturing a superconducting wire rod according to a first embodiment comprises a first, a second, and a third chambers which are connected in series, an exhaust device which exhausts air from the first to third chambers, a carrier device which carries a substrate such that the substrate passes through the first to third chambers in this order, a first film formation device which forms a metal layer on the substrate in the first chamber, a first gas supply device which supplies oxidation gas to the second chamber to oxidize a surface of the metal layer, and a second film formation device which forms an oxide layer on the metal layer, the surface of which has been oxidized, in the third chamber.

A method of manufacturing a superconducting wire rod according to a second embodiment comprises forming a metal layer on a substrate in a vacuum, forming a metal oxide layer by supplying oxidation gas to the metal layer with the vacuum maintained and oxidizing a surface of the metal layer, forming an oxide layer by depositing an oxide on the metal oxide layer with the vacuum maintained, and forming a superconducting layer on the oxide layer.

An embodiment will be explained hereinafter with reference to drawings.

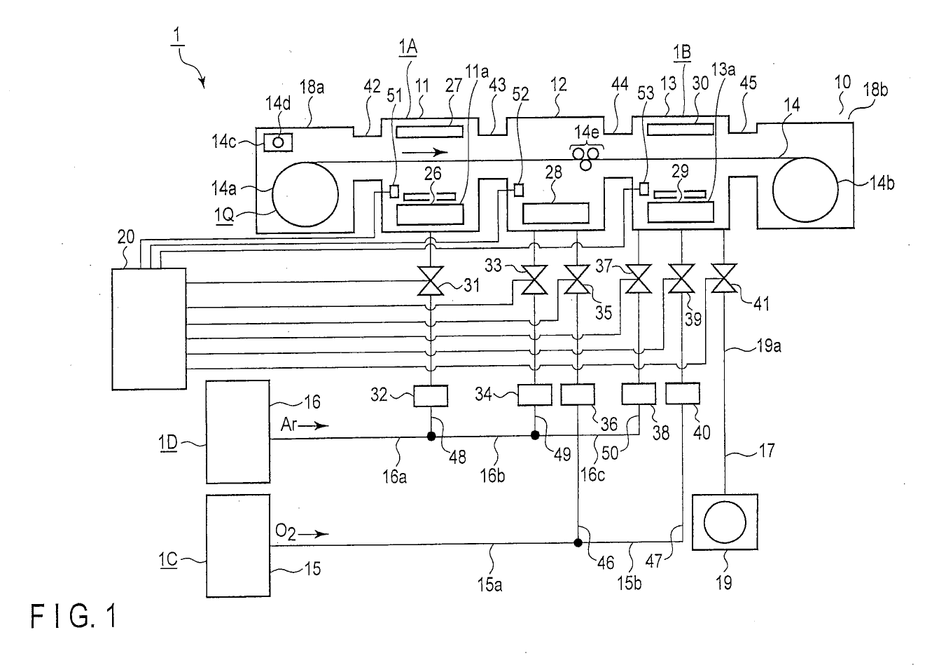

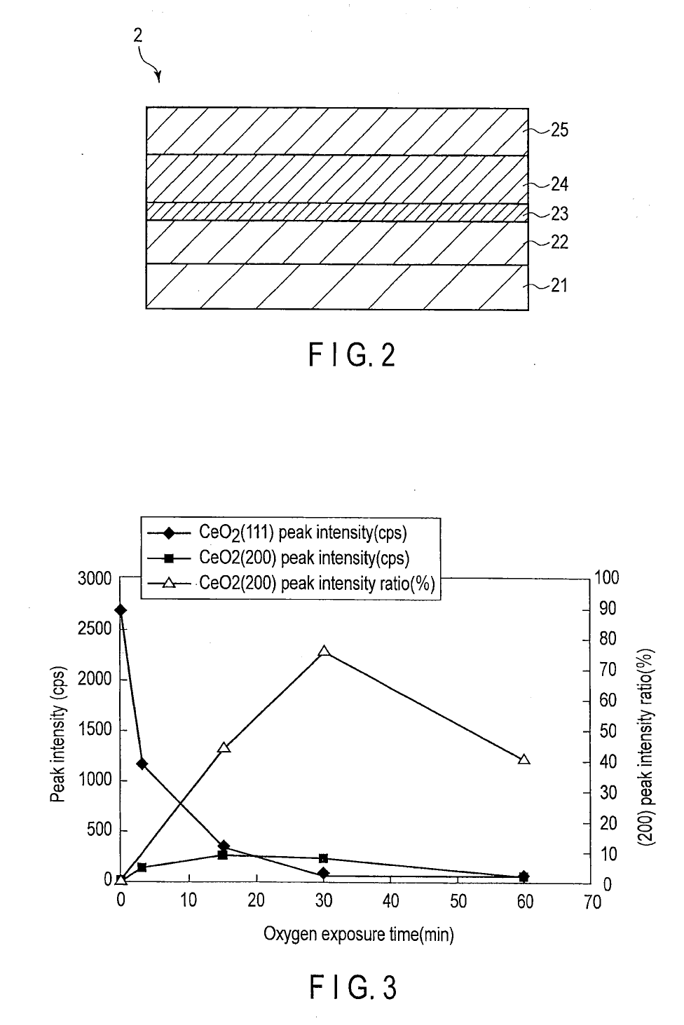

FIG. 1 is a schematic cross-sectional view of a superconducting wire rod manufacturing apparatus 1 according to an embodiment. FIG. 2 is a schematic cross-sectional view of an example of a superconducting wire rod.

A superconducting wire rod 2 illustrated in FIG. 2 has a structure in which a substrate 21, a metal layer 22, a metal oxide layer 23, a buffer layer 24, and a superconducting layer 25 are deposited in this order. According to the manufacturing apparatus 1 illustrated in FIG. 1, it is possible to obtain, for example, the superconducting wire rod 2 as illustrated in FIG. 2.

The manufacturing apparatus 1 illustrated in FIG. 1 comprises a chamber group 10. The chamber group 10 has an airtight structure.

The chamber group 10 includes a first chamber 11, a second chamber 12, and a third chamber 13. The first chamber 11, the second chamber 12, and the third chamber 13 are connected in series. Specifically, the first chamber 11 and the second chamber 12 are connected to each other through a connection part 43. The second chamber 12 and the third chamber 13 are connected to each other through a connection part 44.

The chamber group 10 further includes a reel-out chamber 18a and a reel-in chamber 18b. The reel-out chamber 18a is connected to the first chamber 11 through a connection part 42. The reel-in chamber 18b is connected to the third chamber 13 through a connection part 45.

The manufacturing apparatus 1 further comprises a carrier device 1Q. The carrier device 1Q carries a substrate 21 such that the substrate 21 passes through the first to third chambers 11 to 13 in this order.

The carrier device 1Q includes reels 14a and 14b, and a motor 14c. The reels 14a and 14b are installed in the reel-out chamber 18a and the reel-in chamber 18b, respectively.

The reel 14a is detachably attached to a rotating shaft, such as a rotating shaft 14d of the motor 14c. The reel 14a reels out the substrate 21, that is, long substrate 21 in this example.

The reel 14b is detachably attached to a rotating shaft, such as the rotating shaft 14d of the motor 14c. The reel 14b reels in the processed substrate 21.

The reels 14a and 14b may not be constituent elements of the carrier device 1Q. The carrier device 1Q may further include a guide roller 14e, which are installed in the chamber group 10 and prevent the substrate 21 which is being carried from bending.

The manufacturing apparatus 1 further comprises a first film formation device 1A. The first film formation device 1A forms a metal layer 22 on the substrate 21 in the first chamber 11. Specifically, the first film formation device 1A is a vapor deposition device which forms the metal layer 22 on the substrate 21 by vapor deposition. The method of vapor deposition is, for example, sputtering, deposition, metal organic deposition (MOD), chemical vapor deposition (CVD), or pulsed laser deposition (PLD). For example, when the metal layer 22 is formed by sputtering, the first film formation device 1A includes an application electrode 11a, a heater 26, and a target 27, which are provided in the first chamber 11.

The manufacturing apparatus 1 further comprises a second film formation device 1B. The second film formation device 1B forms a buffer layer 24 on the metal oxide layer 23 in the third chamber 13. Specifically, the second film formation device 1B is a vapor deposition device which forms the buffer layer 24 by vapor deposition. The method of vapor deposition is, for example, sputtering, deposition, MOD, CVD, or PLD. For example, when the buffer layer 24 is formed by sputtering, the second film formation device 1B includes an application electrode 13a, a heater 29, and a target 30, which are provided in the third chamber 13.

The manufacturing apparatus 1 further comprises a first gas supply device 10. The first gas supply device 10 supplies oxidation gas to the second chamber 12 to oxidize the surface of the metal layer 22, and thereby forms the metal oxide layer 23. The first gas supply device preferably supplies oxidation gas such that the gas flows from the first chamber 11 to the third chamber 13.

The first gas supply device 1C includes a tank 15, a first channel 15a, and a second channel 15b.

The tank 15 contains oxidation gas. The oxidation gas is, for example, oxygen, ozone, nitrogen dioxide, or mixture thereof. The oxidation gas may further contain inert gas. As the inert gas, it is possible to use, for example, argon, helium, neon, krypton, xenon, radon, or mixture thereof.

The first channel 15a includes a first supply line 46, and a valve 35 and a mass flow controller (MFC) 36, which are attached to the first supply line 46.

One end of the first supply line 46 is connected to the tank 15, and the other end of the first supply line 46 is connected to the second chamber 12. The first supply line 46 supplies the oxidation gas to the second chamber 12 from the tank 15.

Valve 35 switches a supply/non-supply state of the oxidation gas from the tank 15 to the second chamber 12. A controller 20, which is explained later, is connected to valve 35, and the controller 20 opens and closes valve 35.

MFC 36 controls the flow rate of the oxidation gas in the first supply line 46 to a desired value. MFC 36 is connected with the controller 20. The controller 20 controls a target value of the flow rate controlled by MFC 36.

The second channel 15b includes a second supply line 47, and a valve 39 and an MFC 40 which are attached to the second supply line 47.

One end of the second supply line 47 is connected to the tank 15, and the other end of the second supply line 47 is connected to the third chamber 13. The second supply line 47 supplies the oxidation gas to the third chamber 13 from the tank 15.

Valve 40 switches a supply/non-supply state of the oxidation gas from the tank 15 to the third chamber 13. The controller 20 is connected to valve 40, and the controller 20 opens and closes valve 40.

MFC 40 controls the flow rate of the oxidation gas in the second supply line 47 to a desired value. MFC 40 is connected with the controller 20. The controller 20 controls a target value of the flow rate controlled by MFC 40.

The second channel 15b can be omitted.

The manufacturing apparatus 1 further comprises a second gas supply device 1D. The second gas supply device 1D supplies inert gas to the first to third chambers 11 to 13. Preferably, the second gas supply device 1D supplies the inert gas such that the gas flows from the first chamber 11 to the third chamber 13. The manufacturing apparatus 1 may not include the second gas supply device 1D.

The second gas supply device 1D includes a tank 16, a third channel 16a, a fourth channel 16b, and a fifth channel 16c.

The tank 16 contains inert gas. As the inert gas, it is possible to use, for example, argon, helium, neon, krypton, xenon, radon, or mixture thereof.

The third channel 16a includes a third supply line 48, and a valve 31 and an MFC 32, which are attached to the third supply line 48.

One end of the third supply line 48 is connected to the tank 16, and the other end of the third supply line 48 is connected to the first chamber 11. The third supply line 48 supplies the inert gas to the first chamber 11 from the tank 16.

Valve 31 switches a supply/non-supply state of the inert gas from the tank 16 to the first chamber 11. The controller 20 is connected to valve 31, and the controller 20 opens and closes valve 31.

MFC 32 controls the flow rate of the inert gas in the third supply line 48 to a desired value. MFC 32 is connected with the controller 20. The controller 20 controls a target value of the flow rate controlled by MFC 32.

The fourth channel 16b includes a fourth supply line 49, and a valve 33 and an MFC 34 which are attached to the fourth supply line 49.

One end of the fourth supply line 49 is connected to the tank 16, and the other end of the fourth supply line 49 is connected to the second chamber 12. The fourth supply line 49 supplies the inert gas to the second chamber 12 from the tank 16.

Valve 33 switches a supply/non-supply state of the inert gas from the tank 16 to the second chamber 12. The controller 20 is connected to valve 33, and the controller 20 opens and closes valve 33.

MFC 34 controls the flow rate of the inert gas in the fourth supply line 49 to a desired value. MFC 34 is connected with the controller 20. The controller 20 controls a target value of the flow rate controlled by MFC 34.

The fifth channel 16c includes a fifth supply line 50, and a valve 37 and an MFC 38 which are attached to the fifth supply line 50.

One end of the fifth supply line 50 is connected to the tank 16, and the other end of the fifth supply line 50 is connected to the third chamber 13. The fifth supply line 50 supplies the inert gas to the third chamber 13 from the tank 16.

Valve 37 switches a supply/non-supply state of the inert gas from the tank 16 to the third chamber 13. The controller 20 is connected to valve 37, and the controller 20 opens and closes valve 37.

MFC 38 controls the flow rate of the inert gas in the fifth supply line 50 to a desired value. MFC 38 is connected with the controller 20. The controller 20 controls a target value of the flow rate controlled by MFC 38.

The fourth channel 16b and the fifth channel 16c can be omitted.

The manufacturing apparatus 1 further comprises an exhaust device. The exhaust device 1Q exhausts air from the chamber group. The exhaust device 1Q includes a sixth channel 19a and a pump 19.

The sixth channel 19a includes an exhaust line 17, and a valve 41 which is attached to the exhaust line 17.

The pump 19 is formed of, for example, a cryopump, a turbo-molecular pump, an ion pump, an oil diffusion pump, or a combination thereof. One end of the exhaust line 17 is connected to the pump 19, and the other end of the exhaust line 17 is connected to the third chamber 13. When the pump 19 is driven, gas is discharged from the third chamber 13 through the exhaust line 17.

Valve 41 switches an exhaust/non-exhaust state of the gas from the third chamber 13. Valve 41 is connected with the controller 20, and the controller 20 opens and closes valve 41.

The manufacturing apparatus 1 further comprises sensors 51 to 53. In this example, sensors 51 to 53 are pressure sensors.

Sensors 51 to 53 are provided in the respective chambers 11 to 13. Sensors 51 to 53 are connected to the controller 20. Sensors 51 to 53 sense the pressures of the gases in the respective chambers 11 to 13, and output detection signals to the controller 20.

Sensors 51 to 53 may be omitted. Flowmeters may be provided instead of the pressure sensors. The flowmeters are provided in, for example, the connection parts 43 and 44.

The manufacturing apparatus 1 further comprises the above controller 20.

The controller 20 performs feedback control using, for example, outputs of sensors 51 to 53.

The controller 20 controls the target value of the flow rate controlled by MFC 32, based on the output of sensor 51. According to an example, the controller 20 changes the target value of the flow rate controlled by MFC 32, such that the absolute value of a difference between the actual measurement pressure obtained from the output of sensor 51 and the set pressure has a minimum value. In addition, the controller 20 controls the target values of the flow rates controlled by MFC 34 and MFC 36, based on the output of sensor 52. According to an example, the controller 20 changes the target value of the flow rate controlled by MFC 34 and the target value of the flow rate controlled by MFC 36, such that the absolute value of a difference between the actual measurement pressure obtained from the output of sensor 52 and the set pressure has a minimum value. The controller 20 also controls the target values of the flow rates controlled by MFCs 38 and 40, based on the output of sensor 53. According to an example, the controller 20 changes the target value of the flow rate controlled by MFC 38 and the target value of the flow rate controlled by MFC 40, such that the absolute value of a difference between the actual measurement pressure obtained from the output of sensor 53 and the set pressure has a minimum value.

When flowmeters are used instead of the pressure sensors, the target value of the flow rate controlled by each of MFCs 32, 34 and 38 is controlled, such that the absolute value of a difference between the actual measurement flow rate obtained from the output of the flowmeter and the set flow rate has a minimum value. In addition, for example, when the operator controls the flow rate by manual operation, the controller 20 can be omitted.

Manufacturing of a superconducting wire rod using the manufacturing apparatus 1 is performed by using, for example, the following method.

First, a long substrate 21, which is rolled up, is prepared and set on the reel 14a. As the material of the substrate 21, for example, used is at least one metal selected from the group consisting of nickel, copper, iron and aluminum, or alloy thereof. In the following explanation, suppose that the substrate 21 is a nickel substrate, one principal plane of which is formed of (200) plane.

Next, the reel 14a is attached to the rotating shaft which is installed in the reel-out chamber 18a, and the substrate 21 is reeled out from the reel 14a. Then, one end of the reeled-out substrate 21 is fixed to the rotating shaft which is installed in the reel-in chamber 18b.

Next, under the control of the controller 20, the first and second gas supply devices are operated, to supply oxidation gas to chambers 12 and 13 and supply inert gas to chambers 11 to 13. In addition, under the control of the controller 20, the exhaust device is operated, and thereby the air is exhausted from chambers 11 to 13.

The first gas supply device 10, the second gas supply device 1D, and the exhaust device 1Q control the pressures in the chamber group 10, such that the gases flow from the first chamber 11 to the third chamber 13. Specifically, these devices controls the pressures, such that each of the pressures Pa, Pb, and Pc in the first chamber 11, the second chamber 12, and the third chamber 13, respectively, falls within a range of 0.1 to 10 Pa, and Pa>Pb>Pc. When the pressures are controlled to satisfy the above conditions, the oxidation gas does not flow from the second chamber 12 into the first chamber 11, or oxidize the metal layer 22.

Then, the carrier device 1Q is operated, to reel out the substrate 21 from the reel 14a, and reel in the substrate 21 on the reel 14b.

The substrate 21 which has been reeled out from the reel 14a is carried into the first chamber 11 first, and heated by the heater 26 in the first chamber 11. The heater 26 heats the substrate 21 to a temperature of 100 to 800° C., typically 300 to 600° C. In addition, the second gas supply device supplies the inert gas to the first chamber 11, such that the pressure of the gas in the first chamber 11 falls within a range of 0.1 to 10 Pa, preferably 0.4 to 0.6 Pa, under the control of the controller 20.

A metal layer 22 is formed on the heated substrate 21 by the first film formation device 1A. For example, when the first film formation device 1A forms the metal layer 22 by using sputtering, the inert gas which has been supplied to the first chamber 11 is ionized by the application electrode 11a, and caused to collide with the target 27. Thereby, metal atoms which have been flicked from the target 27 are deposited on the substrate 21 heated by the heater 26. Thereby, the metal layer 22, which has a lattice constant matching with the lattice constant of the substrate 21, is formed.

The target 27 includes the material of the metal layer 22. The material of the metal layer 22 is, for example, at least one metal selected from the group consisting of nickel, copper, and tungsten, or alloy thereof. The material of the metal layer 22 is preferably alloy, which includes nickel, and crystals of which have a plane-centered cubic structure. In this example, for example, suppose that the material of the metal layer 22 is nickel.

The metal layer 22 is material of the metal oxide layer 23. The material of the metal layer 22 may be the same as, or different from, the material of the substrate 21.

The metal layer 22 is formed with a thickness of, for example, 10 to 5000 nm, typically, 500 to 1000 nm.

After the metal layer 22 is formed, the substrate 21 is carried into the second chamber 12 by the carrier device 1Q.

The substrate 21 which has been carried into the second chamber 12 by the carrier device 1Q is heated by the heater 28. The heater 28 heats the substrate 21 to, for example, a temperature of 100 to 800° C., typically, 300 to 600° C. The first gas supply device 1C supplies the oxidation gas to the second chamber 12, under the control of the controller 20, such that the partial pressure of the oxidation gas in the second chamber 12 falls within a range of, for example, 10⁻³ to 10⁻² Pa, preferably, 2.4×10⁻³ to 8×10⁻³ Pa. In addition, the second gas supply device 1D supplies the inert gas to the second chamber 12, under the control of the controller 20, such that the pressure of the gas in the second chamber 12 falls within a range of 0.1 to 10 Pa, preferably, 0.4 to 0.6 Pa.

The oxidation gas which has been supplied to the second chamber 12 oxidizes the surface of the metal layer 22, and thereby the metal oxide layer 23 is formed. For example, when the metal layer 22 is a nickel layer, a nickel oxide layer is formed as the metal oxide layer 23.

The metal oxide layer 23 suppresses oxidation of the metal layer 22 and loss of oxygen in the buffer layer 24, which are caused by direct contact between the metal layer 22 and the buffer layer 24 and contribution of oxygen in the buffer layer 24 to oxidation of the metal layer 22. In the metal oxide layer 23, the components of the metal layer 22 and oxygen form solid solution. Thereby, the metal oxide layer 23 performs a role of bringing the lattice constant of the metal layer 22 close to the lattice constant of the buffer layer 24. The metal oxide layer 23 is formed with a thickness of, for example, 1 to 10 nm, typically, 4 to 6 nm.

When the oxygen partial pressure is too low during this processing, much time is required to obtain the metal oxide layer 23 of a necessary thickness. When the oxygen partial pressure is too high, the surface of the metal layer 22 is excessively oxidized, the orientation of the crystal lattices in the buffer layer 24 cannot be sufficiently controlled, and it is difficult to perform orientation of the superconducting layer 25.

The processing time of the substrate 21 in the second chamber 12 is, for example, 15 to 60 minutes, preferably 15 to 45 minutes. The term “processing time” means time required from the time when the substrate 21 carried by the carrier device 1Q enters the second chamber 12 to the time when the substrate 21 goes out of the second chamber 12.

The metal oxide layer 23 is formed with a thickness of, for example, 1 to 10 nm, typically less than 10 nm, by controlling the flow rate of the oxidation gas, the carrying speed of the substrate 21, and the heating temperature of the substrate 21. When the metal oxide layer 23 is too thick, it is difficult to perform orientation of the buffer layer 24 formed on the metal oxide layer 23, as described above. On the other hand, when the metal oxide layer 23 is too thin, the effect obtained by the metal oxide layer 23 is small.

The substrate 21, on which the metal oxide layer 23 has been formed, is carried into the third chamber 13 by the carrier device 1Q.

The substrate 21 which has been carried into the third chamber 13 by the carrier device 1Q is heated by the heater 29. The heater 29 heats the substrate 21, the metal layer 22, and the metal oxide layer 23 to, for example, a temperature of 100 to 800° C., typically, 300 to 600° C. The first gas supply device 1C supplies the oxidation gas to the third chamber 13, under the control of the controller 20, such that the partial pressure of the oxidation gas in the third chamber 13 falls within a range of, for example, 1.5×10⁻³ to 1.5×10⁻² Pa, preferably, 6×10⁻³ to 9×10⁻³ Pa. In addition, the second gas supply device 1D supplies the inert gas to the third chamber 13, under the control of the controller 20, such that the pressure of the gas in the third chamber 13 falls within a range of 0.1 to 1 Pa, preferably, 0.4 to 0.6 Pa.

The buffer layer 24 is formed on the heated metal oxide layer 23 by the second film formation device 1B. For example, when the second film formation device 1B forms the buffer layer 24 by using sputtering, the inert gas which has been supplied to the third chamber 13 is ionized by the application electrode, and caused to collide with the target 30. Thereby, oxide molecules which have been flicked from the target 30 are deposited on the metal oxide layer 23 heated by the heater 29. Thereby, the buffer layer 24, which has a lattice constant matching with the lattice constant of the metal layer 22 and/or the metal oxide layer 23, is formed.

The target 30 includes the material of the buffer layer 24. The material of the buffer layer 24 is, for example, SrRuO₂, SrTiO₂, LaMnO₂, (La, Sr)MnO₂, LaNiO₂, EU₂O₂, CeO₂, Gd₂O₂, La₂Zr₂O₇, LaAlO₃, Y₂O₃, Gd₂Zr₂O₇, Y₃NbO₇, Yb₂O₂, and yttria stalibized zirconia (YSZ).

The material of the buffer layer 24 is preferably a metal oxide, which has a lattice constant and a crystal structure that are the same as or similar to those of the metal used as the material of the metal layer 22. For example, when nickel is used as the material of the metal layer 22, it is preferable to use a metal oxide which has a lattice constant close to the lattice constant of nickel and the same plane-centered cubic structure, such as CeO₂, YSZ, and Y₂O₃, as the material of the buffer layer 24.

The buffer layer 24 has the function of promoting orientation of the superconducting layer 25. In this example, suppose that the buffer layer 24 is, for example, a cerium oxide layer, an upper surface of which is formed of (200) plane.

The buffer layer 24 is formed with a thickness of, for example, 20 to 1000 nm, typically, 50 to 100 nm.

After the buffer layer 24 is formed, the substrate 21 is reeled in on the reel 14b installed in the reel-in chamber 18b, by the carrier device.

Thereafter, the reel 14b, around which the substrate 21 is wound, is taken out of the reel-in chamber 18b, and the superconducting layer 25 is formed on the buffer layer 24. The superconducting layer 25 is formed by, for example, PLD, sputtering, deposition, or TFA-MOD. The superconducting layer 25 is formed of, for example, YBa₂Cu₃O₇-δ or Bi₂Sr₂Ca₂Cu₃O₁₀.

The superconducting wire rod 2 is obtained as described above.

When the superconducting layer 25 is formed in a vacuum, another chamber may be provided between the third chamber 13 and the reel-in chamber 18b, and the superconducting layer 25 may be formed in the chamber.

The substrate 21 may be etched, before formation of the metal layer 22 in the first chamber 11. When the substrate 21 is etched, for example, an etching chamber is provided between the first chamber 11 and the reel-out chamber 18a, and the substrate 21 is etched in the etching chamber. The etching is preferably dry etching. The method of etching is, for example, reverse sputtering.

In this processing, one or more additional buffer layers may be formed, in addition to the buffer layer 24. One or more additional buffer layers are formed on the buffer layer 24. When one or more additional buffer layers are formed, one or more fourth chambers and one or more third film formation devices are provided, and the additional buffer layers are formed in respective fourth chambers by respective third film formation devices. The fourth chambers are connected to the third chamber in series, and provided between the third chamber 13 and the reel-in chamber 18b. The number of the fourth chambers and the number of the third film formation devices can be selected in accordance with the number of additional buffer layers to be formed. Although the material of the additional buffer layers is selected from materials which can be used as the material of the buffer layer 24, the material of the additional buffer layers is preferably different from the material used for the buffer layer 24. The additional buffer layers are formed by the same method as that of the buffer layer 24.

In the prior method, a natural oxide film is formed on the surface of the metal substrate, for example, nickel substrate, and thus it is necessary to subject the natural oxide film to hydrogen reduction. In this method, it is difficult to obtain reproducibility for the state of the natural oxide film after hydrogen reduction, and thus it is difficult to match the lattice constant of the buffer layer with the lattice constant of the metal substrate with good reproducibility.

According to the manufacturing apparatus 1 of the embodiment, it is possible to successively process the substrate 21 in the chamber group 10, with the vacuum maintained. Therefore, no natural oxide film is formed on the surface of the metal layer 22, and thus it is unnecessary to perform reduction processing with reduction gas. This removes the problem that the reduction gas flows into the downstream of the chamber group 10 and the reduction gas is mixed into the oxide buffer layer, and it is possible to form buffer layer 24 of high purity. In addition, in the manufacturing apparatus 1, the metal layer 22 is formed by depositing metal on the substrate 21 by the first film formation device, and thereafter the metal oxide layer 23 is formed on the metal layer 22 by the first gas supply device. Therefore, the surface of the metal layer 22 formed on the substrate 21 is not oxidized until processing performed by the first gas supply device 1C, and no impurities such as water and carbon adhere to the surface of the metal layer 22. It is thus possible to perform oxidation of the metal layer 22 by the first gas supply device 1C with good reproducibility. According to the above structure, it is possible to obtain the metal oxide layer 23 with good reproducibility, and achieve lattice matching for the buffer layer 24 formed thereon and the superconducting layer 25 which is further formed on the buffer layer 24, with good reproducibility. In particular, in manufacturing of high-temperature superconducting wire rods which have excellent performance, it is necessary to make the crystal orientation of the high-temperature superconducting layer uniform in a three-dimensional manner, specifically, it is necessary to perform biaxial orientation. According to the manufacturing apparatus 1, it is possible to achieve biaxial orientation of the high-temperature superconducting layer. As described above, since superconducting wire rods can be manufactured with good reproducibility, it is possible to improve the yield according to the manufacturing apparatus 1.

In addition, when the first gas supply device 1C and/or the second gas supply device 1D supply oxidation gas and/or inert gas such that the gases flow from the first chamber 11 to the third chamber 13, it is possible to prevent the oxidation gas from flowing from the second chamber 12 into the first chamber 11, and prevent the metal layer 22 from being oxidized by the oxidation gas which has flowed into the first chamber 11.

Besides, since the metal oxide layer 23 is formed by oxidizing the surface of the metal layer 22 by the oxidation gas supplied from the first gas supply device 1C, it is possible to control the thickness of the metal oxide layer 23. For example, when the metal oxide layer 23 is formed on the metal layer 22 by deposition, a certain film thickness is required to cover the metal layer 22, and it is difficult to control the thickness of the metal oxide layer 23. According to the manufacturing apparatus 1, however, the degree of oxidation of the metal surface can be controlled as desired, by changing the flow rate of the oxidation gas and the carrying speed and the heating temperature of the substrate 21. Therefore, it is also possible to control the thickness of the metal oxide layer 23.

In addition, when the metal oxide layer 23 is formed on the metal layer 22, it is generally difficult to control the film thickness, and thus it is difficult to make the orientations of the crystal grains uniform. In the manufacturing apparatus 1, the metal oxide layer 23 is formed by oxidizing the surface of the oriented metal layer 21, the thickness of the metal oxide layer 23 can be controlled in a very narrow range, and thus the orientations of the crystal grains can be more easily made uniform. Therefore, the oxide buffer layer 24 formed on the metal oxide layer 23 can be easily oriented.

As described above, according to the manufacturing apparatus 1 of the embodiment, an oriented underlayer for the superconducting wire rod is formed, and thereby it is expected to obtain a superconducting wire rod having excellent superconducting property.

### Example 1

A substrate 21, one principal plane of which was formed of (200) plane was prepared.

A superconducting wire rod was manufactured by using the above manufacturing apparatus 1. The details and conditions of processing in each chamber of the manufacturing apparatus 1 are as follows.

1. Processing in First Chamber 11

Under the following conditions, a nickel layer 22 having a thickness of 1000 nm was formed on the substrate 11 by sputtering.

Argon partial pressure: 0.45 Pa

Substrate temperature: 300° C.

2. Processing in Second Chamber 12

Under the following conditions, a surface of the nickel thin film which was formed in the first chamber 11 was oxidized, and thereby a nickel oxide layer 23 having a thickness of 4.5 nm was formed.

Oxygen partial pressure: 3.6×10⁻³ Pa

Substrate temperature: 300° C.

Oxygen exposure time: 15 minutes

3. Processing in Third Chamber 13

Under the following conditions, buffer layer 24 formed of CeO₂ and having a thickness of 75 nm was formed by sputtering, on the nickel oxide layer 23 which was formed in the second chamber 12.

Argon partial pressure: 0.45 Pa

Oxygen partial pressure: 7.5×10⁻³ Pa

Substrate temperature: 300° C.

### Examples 2 to 4

In Examples 2 to 4, the oxygen exposure time in the second chamber 12 was set to 15 minutes, 30 minutes, and 60 minutes, respectively. Except for the oxygen exposure time, the substrate 1 was processed in the same manner as Example 1.

### Comparative Example

The oxygen exposure time in the second chamber 12 was set to 0 minute. Except for the oxygen exposure time, the substrate 1 was processed in the same manner as Example 1.

<Evaluation>

X-ray diffraction spectra for samples obtained by Examples 1 to 4 and Comparative Example 1 were obtained by using an X-ray diffraction apparatus (D8-DISCOVER, manufactured by Bruker AXS).

Based on the obtained spectra, (200) peak intensity ratios (%) of CeO₂ were calculated. The (200) peak intensity ratios (%) were obtained based on the following expression.

(200) peak intensity ratio (%)=(200) peak intensity/[(200) peak intensity+(100) peak intensity]

FIG. 3 illustrates the results thereof. FIG. 3 is a graph illustrating the relationship between the oxygen exposure time and the peak intensity ratio of each lattice plane forming CeO₂.

FIG. 3 shows that the peak intensity ratio of the (200) plane in the CeO₂ layer can be increased by increasing the exposure time, when the oxygen exposure time is 30 minutes or less, under the condition that the oxygen partial pressure is 3.6×10⁻³ Pa. FIG. 3 also shows that the intensity ratio decreases when the exposure time exceeds 30 minutes, under the condition that the oxygen partial pressure is 3.6×10⁻³ Pa.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A manufacturing apparatus which manufactures a superconducting wire rod, comprising:
first, second, and third chambers which are connected in series;
an exhaust device which exhaust air from the first to third chambers;
a carrier device which carries a substrate such that the substrate passes through the first to third chambers in this order;
a first film formation device which forms a metal layer on the substrate in the first chamber;
a first gas supply device which supplies oxidation gas to the second chamber to oxidize a surface of the metal layer; and
a second film formation device which forms an oxide layer on the metal layer, the surface of which has been oxidized, in the third chamber.

2. The manufacturing apparatus according to claim 1, further comprising:
a second gas supply device which supplies inert gas to the first to third chambers,
wherein the exhaust device is connected to the third chamber, and the first and second gas supply devices supply the oxidation gas and the inert gas, respectively, such that the gases flow from the first chamber to the third chamber.

3. The manufacturing apparatus according to claim 2, further comprising:
a controller which controls operation of the first and second gas supply devices such that the gases flow from the first chamber to the third chamber.

4. The manufacturing apparatus according to claim 2, wherein
the substrate is long material, and the carrier device carries the long material in its longitudinal direction in each of the first to third chambers.

5. The manufacturing apparatus according to claim 1, wherein
each of the first and second film formation devices is a vapor deposition device.

6. The manufacturing apparatus according to claim 1, further comprising:
at least one fourth chamber which is connected to the third chamber in series; and
at least one third film formation device which forms at least one additional oxide layer on the oxide layer in the fourth chamber.

7. A method of manufacturing a superconducting wire rod, comprising:
forming a metal layer on a substrate in a vacuum;
forming a metal oxide layer, by supplying oxidation gas to the metal layer with the vacuum maintained and thereby oxidizing a surface of the metal layer;
forming at least one oxide layer, by depositing at least one oxide on the metal oxide layer with the vacuum maintained; and
forming a superconducting layer on the at least one oxide layer.

8. The method according to claim 7, wherein
the forming at least one oxide layer is forming a plurality of oxide layers.
